(19) United States
(12) Patent Application Publication
(10) Pub. No.: US 2007/0112243 A1
(43) Pub. Date: May 17, 2007

(54) Bimetallic Treatment System and its Application for Removal and Remediation of Polychlorinated Biphenyls (PCBs)

(75) Inventors: Jacqueline W. Quinn, Titusville, FL (US); Kathleen B. Brooks, Orlando, FL (US); Cherie L. Geiger, Geneva, FL (US); Christian A. Clausen, Chuluota, FL (US)

Correspondence Address: NASA JOHN F. KENNEDY SPACE CENTER, MAIL CODE: CC-A/OFFICE OF CHIEF COUNSEL, ATTN: PATENT COUNSEL, KENNEDY SPACE CENTER, FL, 32899, US

(73) Assignee: United States of America as Represented by the Administrator of the National Aeronautics and Spac, Washington, DC (US)

(21) Appl. No.: 11/462,741

(22) Filed: Aug. 7, 2006

Related U.S. Application Data
(60) Provisional application No. 60/708,126, filed on Aug. 11, 2005.
(60) Provisional application No. 60/708,127, filed on Aug. 11, 2005.

(51) Int. Cl. A62D 3/30

(52) U.S. Cl. 588/313

(57) ABSTRACT

PCBs are removed from contaminated media using a treatment system including catalyzed zero-valent metal particles and an organic hydrogen donating solvent. This treatment system provides a major benefit of eliminating PCBs in situ. The treatment system provides a “paste”-like system that is preferably applied to natural media and ex-situ structures.

### CROSS-REFERENCE TO RELATED APPLICATIONS

This application claims the benefit under 35 U.S.C. 119(e) of U.S. Provisional Application Ser. No. 60/708,126 filed Aug. 11, 2005, and U.S. Provisional Application Ser. No. 60/708,127 filed on Aug. 11, 2005, the contents of which are incorporated herein by reference.

### ORIGIN OF INVENTION

The invention described herein was made in the performance of work under a NASA contract and by an employee of the United States Government and is subject to the provisions of Public Law 96-517 (35 U.S.C. §202) and may be manufactured and used by or for the Government for governmental purposes without the payment of any royalties thereon or therefore.

### BACKGROUND OF THE INVENTION

1. Field of the Invention

The present invention is directed to a treatment system for the remediation of polychlorinated biphenyls (PCBs), chlorinated pesticides, and other halogenated compounds. Specifically, the treatment system comprises a plurality of catalyzed zero-valent metal particles and a hydrogen donating solvent.

2. Description of Related Art

PCBs are a group of synthetic aromatic compounds with the general formula C₁₂H₁₀₋ₓClₓ. PCBs are among the most persistent, bioaccumulative, and toxic compounds and are responsible for the primary risk at numerous sediment sites. PCBs are a group of synthetic aromatic compounds that were historically used in industrial paints, caulking material, and adhesives, as their properties enhanced structural integrity, reduced flammability, and boosted antifungal properties. PCBs have been used in many industrial applications because of their robust physical and chemical properties such as their resistance to acids, bases, and oxidation, their excellent dielectric characteristics, and their thermal stability at high temperatures (up to 350° C.). When PCBs were released into the environment, they were sorbed to particulate matter that was then dispersed over large areas. PCBs can be introduced into the food chain by the uptake of contaminated soils by biota and humans can directly inhale or absorb PCBs by dermal contact.

Although the United States Environmental Protection Agency (USEPA) has banned the manufacture of PCBs since 1979, PCBs are still present in the environment posing possible adverse health affects to both humans and animals. Prior to the USEPA's ban on PCB production, PCBs were commonly used as additives in paints and asphalt-based adhesives that were subsequently applied to a variety of structures. Governmental facilities constructed as early as 1930 utilize PCB-containing binders or PCB-containing paints, which are now leaching into the environment and posing ecological and worker health concerns. PCBs have been found in at least 500 of the 1,598 National Priorities List (Superfund) sites identified by USEPA. Many of the most costly cleanups are at sediment sites dominated by PCB contamination. Additionally, PCBs can still be found in the paints located on NASA property at a number of NASA Centers. The PCB and metal levels in painted structures on Kennedy Space Center have been documented to be as high as 31,000 ppm. PCBs have been introduced into the NASA work environment via improper disposal and accidental leaks from transformers, heat exchanges, and hydraulic systems. Numerous NASA Centers have older metal structures upon which paints containing PCBs were applied. These painted structures are posing worker and ecological health hazards and, in several instances, are now considered a TSCA-level (Toxic Substance Control Act) waste. Some of the impacted structures could be refurbished and utilized for new programs, but because the paint currently on the structures is heavily laden with PCBs, the programs are unable to reuse or even discard these structures without significant cost.

The removal of contaminants from natural resources and structures is an ongoing, significant problem. Because of the serious health problems associated with the bioaccumulation of PCBs in animals, including humans, and the desire for NASA programs to have a quick non-destructive means of removing PCBs from existing structures, numerous tactics have been considered with various degrees of success. To date, no definite in-situ, non-destructive method is available for the remediation of PCBs found in natural media. Current technologies as listed below require costly dredging or excavating and are environmentally unfriendly. This costly alternative required heavy machinery to physically remove the contaminated soil. The soil removed is considered a TSCA regulated waste and must be disposed of via:
1. TSCA Landfill (performance-based disposal). This option is cost-prohibitive for large contamination sites. There is still the ultimate long-term environmental liability with off-site disposal of the high concentration paint.
2. On-Site Landfill (risk-based disposal). This option requires a State permit for a site-owned and operated landfill (open-ended, risk based approval). This option transfers the potential for leaching into natural resources onto an on-site landfill, and still retains all its long-term environmental liability.
3. Smelters (performance-based disposal, decontamination provisions). The concentrations of PCBs in soils to be smelted must be less than 500 ppm. This option is often cost prohibitive especially when combined with the costly step of dredging. In addition to the expense associated with dredging, this option has a tremendous impact on the environment.
   Currently, only land filling or smelting operations are available for complete treatment of ex-situ structures containing metals and PCBs. Sandblasting or water blasting operations can be utilized to remove contaminated coatings from structures; however, this material must also be thermally treated or land filled in a TSCA regulated landfill.

In the invention disclosed in U.S. Pat. No. 6,664,298 filed on Oct. 2, 2001, and incorporated into the present application by express reference thereto, a method was disclosed for delivering a reactive material to a contaminant in situ. The method incorporated the concept of either emulsification of the reactant or encapsulation of the reactant prior to its delivery to the contaminant in situ. The method disclosed and claimed in U.S. Pat. No. 6,664,298 has particular success in using a zero-valent metal emulsion containing metal particles, surfactant, oil and water in a method of enhancing dehalogenation of dense non-aqueous phase liquid (DNAPL) sources. While it is known that zero-valent iron is very effective in the treatment of chlorinated hydrocarbons, such as dissolved trichloroethylene (TCE), zero-valent iron, by itself, is unable to completely dechlorinate PCBs or more robust halogenated compounds such as chlorinated pesticides dissolved in aqueous solutions.

In the invention disclosed in U.S. Pat. No. 7,008,964, filed on May 28, 2003, and incorporated into the present application by express reference thereto, another emulsion system for remediating contaminated media is disclosed. A zero-valent metal emulsion containing zero-valent metal particles doped with a catalytic metal is disclosed to remediate halogenated aromatic compounds, such as PCBs, from natural resources, i.e., in the ground. However, this option for the removal of PCBs found in natural media using an emulsion has several limitations. This emulsion includes emulsion particles comprised of an aqueous interior with bimetal particles encapsulated in a surfactant stabilized hydrophobic solvent membrane. The use of a water-only solvent interior continuum has several disadvantages. Most importantly, making the aqueous-based emulsion requires the potentially hazardous step of adding pure water to the catalytic metal coated zero-valent metal particle. This step is particularly hazardous because:
1. This step produces significant amounts of hydrogen gas which is flammable.
2. The metal particles are so small and light that they produce a dust cloud of catalyzed particles in air when mixed with water. Because of the large surface area of the catalyzed particles, this dust cloud is a potential explosion hazard.
3. The reaction itself is exothermic producing heat that is inherently dangerous in the presence of hydrogen gas.
4. Catalytic metals, such as palladium, within a bimetal particle when mixed with hydrogen gas have the unique ability to produce atomic hydrogen at the metal surface which is extremely reactive. The addition of atomic hydrogen with any of the hazards previously listed increases the likelihood of unexpected explosions or fire.
   Along with the significant hazards associated with the production of the previous emulsion, the reaction of the bimetal particle with water itself is a competing reaction that affects the dehalogenation of PCBs. Recent laboratory studies have shown that when excess water is in the presence of the bimetal particle for a significant amount of time (greater than 24 hours) before exposure to the PCBs, the PCBs degradation is hindered. This is due to the water depleting the zero-valent metal particle which supplied necessary electrons to the dehalogenation reaction. While the bimetallic particles have been shown to effectively degrade dissolved phase PCBs, the use of bimetallic particles to treat impregnated PCBs would be minimized by the coating material itself.

### BRIEF SUMMARY OF THE INVENTION

The present invention is directed to a treatment system comprising a plurality of catalyzed zero-valent metal particles and an organic hydrogen donating solvent. This treatment system provides a major benefit of eliminating PCBs in situ. Destruction of the PCB offers one of the greatest benefits, as only PCB destruction can eliminate future liabilities. The treatment system provides a “paste”-like system that is preferably applied to natural media and ex-situ structures. As will become clear, the present invention expands on the concept described in the previously cited applications to effectively remove and remediate PCBs and other halogenated compounds such as chlorinated pesticides found in natural media, painted structures, and other ex-situ facilities.

In a first preferred embodiment, the treatment system is used for the in-situ remediation of PCBs, chlorinated pesticides, and other halogenated compounds found in natural media including groundwater, surface water, sediment, and soil. The present treatment system has the advantage that it does not negatively alter the natural media, allowing the contaminant to be treated in situ without costly dredging, therefore decreasing the impact of cleanup. Additionally, the treatment system provides no hazardous by-products, which eliminates long-term environmental liabilities, minimizes the potential of leaching or spreading hazardous waste into the environment, and eliminates costly hazardous waste disposal costs.

In a second preferred embodiment, the treatment system is used for the removal and destruction of PCBs found in ex-situ structures, such as painted structures, or within the binding or caulking material on ex-situ structures. The treatment system could be very beneficial to entities responsible for PCB-laden structures and other PCB contamination problems. Not only are these structures a demolition hazard, they are allowing constant leaching of PCBs into surrounding soils and other natural media. Sites containing PCBs in their structures include the U.S. Navy, Army, utility companies, etc. The present invention provides an in-situ PCB remediation process that is applicable for the treatment of ex-situ structures containing metal and PCB compounds within externally applied coatings such as paint. The treatment system extracts and degrades only the PCBs found in the structure, leaving in most cases the structure virtually unaltered. The present treatment system as applied to ex-situ structures functions to disassociate the PCBs from the coating, i.e. paint, and degrades the chlorinated aromatics into biphenyl, a benign by-product. The treatment system may be applied using a “paint-on and wipe-off” process, that in the end leaves the structure PCB-free and virtually unaltered in physical form. The treatment system may also be applied utilizing dip tanks where pieces of caulking or adhesives are treated in batches prior to non-TSCA regulated disposal. The present treatment system has far reaching implications to older facilities across the world; allowing them to be remediated and reused by implementing a PCB cleanup technology that removes and degrades the PCBs while on the structure.

### BRIEF DESCRIPTION OF THE DRAWINGS

The features and advantages of the present invention will become apparent from the following detailed description of a preferred embodiment thereof, taken in conjunction with the accompanying drawings, in which:

FIG. 1 is a diagram of a preferred use of the present treatment system on a contaminated structure;

FIG. 2 is a chromatograph of an Arochlor 1260 standard;

FIG. 3 is a chromatogram of the Arochlor 1260 standard exposed to bare Mg/Pd for 5 minutes;

FIG. 4 is a chromatogram of the Arochlor 1260 standard exposed to bare Mg/Pd for 1 hour;

FIG. 5 is a chromatogram of the Arochlor 1260 standard exposed to bare Mg/Pd for 4 hours;

FIG. 6 is a chromatogram of a control sample of River A sediment (top) and a treated sample of River A sediment (bottom); and

FIG. 7 is a graph showing the total PCB concentration in a control sample of River A and River B sediments compared with treated samples.

### DETAILED DESCRIPTION OF THE INVENTION

The present invention is directed to a treatment system comprising a plurality of catalyzed zero-valent metal particles and an organic hydrogen donating solvent. The reference to “an organic hydrogen donating solvent” should be construed to include solvents that only include organic compounds as well as solvents that include organic compounds and non-organic compounds, such as water. The preferred organic hydrogen donating solvents include, but are not limited to, alcohols. Most preferably, the alcohols are diols, triols, ethanol, methanol, glycerin, and mixtures thereof. As indicate above, any of these organic compounds may also be preferably mixed with water to form the organic hydrogen donating solvent. The preferred catalyzed zero-valent metal particles are bimetallic particles wherein a zero-valent metal particle is coated with a catalytic metal. Most preferably, the bimetallic particle is formed from a zero-valent iron (Fe) or zero-valent magnesium (Mg) particle coated with a noble metal. Most preferably, the noble metal is palladium (Pd), nickel (Ni), zinc (Zn) or a mixture thereof. In a preferred embodiment, the zero-valent metal particles are microscale or nanoscale zero-valent magnesium or zero-valent iron particles. Preferably, the microscale particles would have a diameter in the range of 1-3 microns. Whereas, the preferred nanoscale particles would have a diameter in the range of 20-300 nm. It should be understood that other zero-valent metal particles and combinations may be used. The catalytic metal is preferably selected from the group consisting of noble metals and transition metals. The preferred mass percent palladium by weight ranges from approximately 0.08-8%, but higher and lower ranges could still yield positive results.

In one preferred embodiment, the bimetallic particles may be formed using a mechanical alloying technique. Mechanical alloying is a high-energy milling process for producing composite materials with an even distribution (though not homogeneous in the rigorous sense) of one material into another. By definition, at least one of the materials must be metallic to be considered an alloy. The mechanical alloying techniques most commonly used involve ball milling, vibratory milling, attrition, or roller milling. Ball milling is a process in which a material is loaded into a canister partially filled with milling balls. The canister is then rotated at high speed on its major axis so that the balls are held by centripetal force to the inside wall until they reach the highest point inside the canister. Gravitational force then exceeds the upward force of the balls and they fall to the bottom of the canister where they impact other balls and the canister wall. The approximate critical speed of any ball mill is given below and is usually on the order of about 250 RPMs,
N_{c}=7.05/(D^{1/2})

where N_{c}=critical speed and D=milling canister diameter

Vibrator milling is a process similar to ball milling except that the milling vessel is vigorously shaken in a back and forth motion or in a back in forth motion in conjunction with a lateral motion that produces a “figure 8” path. This type of milling relies solely on the extremely high-energy collisions between rapidly moving milling balls rather than the collisions between the balls and the canister wall, as described for ball milling. Since vibrator mills can often shake canisters at a rate of approximately 1200 RPMs, often producing ball speeds of upwards of 5 m/s, vibrator milling commonly yields the desired reduction in particle size at a rate one order of magnitude faster than that of ball milling. Two other less common types of milling are attrition milling and roller milling. These processes are not commonly seen in laboratory settings but are often seen in industrial work. Attrition milling relies on rapidly spinning paddles to stir the milling balls present in the milling vessel. The rate of size reduction observed is often similar to the rate of reduction observed for vibrator mills of similar size; however, due to the necessity of a cooling system this type of milling is often limited in its capabilities to systems that can be milled in liquid media. Roller Milling is a process that relies on fracturing caused by stress induced in the system from the compression of materials between two rolling bars or cylinders. It is most often used for reduction of very coarse materials into less coarse materials that can later be reduced in size by other means. For all milling types, the reduction of particle size relies on stresses induced in individual particles caused by collisions within the milling vessel. This process reduces the average particle size until equilibrium is reached, at which point no further size reduction is observed.

In a preferred embodiment of the present invention, Mg/Pd bimetallic particles may be produced using relatively short milling times, with the high-energy vibrational mill previously described, to avoid complete dissolution of the small quantity of brittle palladium into the large quantity of malleable magnesium. For the scale up, a paint shaker fitted with custom plates to hold the milling canisters may be chosen as the mill engine. Tungsten Carbide is preferably used as the milling vessel material in most high-energy, small-scale mills because it is extremely durable and does not break down over time or cause the introduction of contaminates into the milling material. The use of an extremely durable milling vessel is not necessary for producing the Mg/Pd bimetallic particles because the introduction of some contaminates would not appreciably affect the reactivity of the metal, thus galvanized steel pipes (purchased from Ace Hardware with internal diameter—5.03 cm, length—17.8cm) with steel end caps were used. Steel ball bearings (mass—22.3grams each, volume—1.6 cm³ each) were chosen as the preferred grinding matrix. Since the paint shaker chosen operates at approximately 600 RPMs (as opposed to 1250 RPMs observed for the Spex Centi-prep) longer milling times were necessary. It has already been shown that most often, the optimum rate of comminution is observed when milling canisters are filled 40-60% with grinding materials and 10-20% with particulate material, by volume. It was determined that longer milling times actually reduced the rate of dechlorination. Longer milling times cause the palladium to be completely embedded into the magnesium thereby producing less active surface. Therefore, the optimum milling time is in the range of 20-40 min.

U.S. patent application Ser. No. 10/977,622 discloses a preferred ball milling process for making the bimetallic particles. U.S. patent application Ser. No. 10/977,622 is incorporated in the present application by express reference thereto. The preferred ball milling process includes milling the zero-valent metal particle with the catalytic metal to form the bimetallic particle. In the ball milling process, the zero-valent metal particle has a particle size of less than about 10 microns, preferably 0.1-10 microns or smaller, prior to milling. In the preferred ball milling process, the catalytic metal is supported on a carbon support structure prior to milling. The zero-valent metal particle (e.g. microscale magnesium) is preferably ball milled with 1-10% palladium supported on carbon. The preferred mass percent palladium by weight ranges from approximately 0.01-15%, and more preferably 0.08-8%.

U.S. Pat. No. 7,008,964 discloses a preferred process for making the bimetallic particles by coating a zero-valent particle with a catalytic metal. U.S. Pat. No. 7,008,964 is incorporated in the present application by express reference thereto. In this preferred embodiment, microscale zero-valent iron is coated with palladium (Pd) using a solution of K₂PdCl₆ as follows. Approximately 100 g of microscale zero-valent iron particles, such as provided by Alfa Aesar, Inc. or BASF, Inc., is weighed and placed in a Buchner Funnel. The microscale zero-valent iron particles are then washed with 100 ml of a 5% hydrochloric (HCI) or sulfuric (H₂SO₄) solution (5 mL HCL or H₂SO₄ and 95 mL of Deoxygenated DI water). The microscale zero-valent iron particles are then filtered. Then 0.19 g of K₂PdCl₆ is weighed out and dissolved in 100 mL of deoxygenated DI water. All of the filtered microscale zero-valent iron particles are placed in an Erlenmeyer flask and the K₂PdCl₆ solution was added. The resulting mixture is stirred in the flask using a magnetic stirrer for 5 minutes. The solution is then allowed to settle and filtered until dry. The resulting bimetallic microscale particles have a palladium coating of approximately 0.06% Pd/Fe. In a second preferred embodiment, microscale zero-valent iron is coated with palladium (Pd) using a 40 g/L Pallamerse solution. The Pallamerse solution is made up of 10.0% potassium dinitrosulfate palladate (II), K₂(Pd(NO₂)₂SO₄. The following procedure indicates a preferred method for coating 2.5 g of microscale zero-valent iron particles. The microscale zero-valent iron particles are washed in a Buchner Funnel with 10 mL of 10% H₂SO₄ solution. The microscale zero-valent iron particles are then rinsed with 10 mL of deoxygenated DI water. Then, 5 mL of the Pallamerse solution is then added and the mixture is allowed to sit for 2 minutes before filtering. After the mixture is filtered, the microscale zero-valent iron particles are washed with 10 mL of deoxygenated DI water. The material is then filtered until dry. The resulting bimetallic microscale particles had a palladium coating of approximately 7% Pd/Fe.

The treatment system is preferably formulated as a “paste-like” system that contains the catalyzed zero-valent metal particles and the organic hydrogen donating solvent within a thickener and a stabilizing agent. In a preferred embodiment, a “paste-like” system is formed by coating the catalyzed zero-valent metal particles with glycerin in an ethanol solution with calcium stearate added as a thickener. Other thickeners may be added including, but not limited to, PEG, glycerin, paraffin, stearate, and mixtures thereof. In this preferred embodiment, glycerin is used as a stabilizing agent. However, other stabilizing agents include, but are not limited to, mineral oil, vegetable oil, or mixtures thereof. In this preferred embodiment, calcium stearate is used as the thickener. However, the thickener may also be a starch.

The treatment system is used to treat PCB or other halogenated compounds to degrade the PCB into a benign end-product. It should be understood that any reference to PCBs in the present application also expressly includes a reference to other suitable halogenated compounds, including, but not limited to Chlordane and DDT. Once in contact with contaminated media, the PCBs diffuse into the treatment system and undergo degradation. The PCBs continue to enter, diffuse, and degrade into non-halogenated end-products. The present treatment system has found particular use in remediating PCB-containing natural media and ex-situ structures.

In a first embodiment, the treatment system is applied to natural media. The treatment system causes the PCB to be extracted or removed from the media (e.g. soil or sediment), and degrades the chlorinated aromatics into biphenyl or other non-chlorinated benign by-products.

In a preferred embodiment of the present invention used in treating natural media, the treatment system comprises zero-valent magnesium (Mg) particles coated with a small amount of palladium (Pd) utilized in conjunction with an organic hydrogen donating solvent, preferably alcohols and water. The treatment system has two functions in remediating sediments: first, to adsorb the PCBs from the soil matrix; second, to degrade the extracted PCBs. The process for sorbing the PCB molecules from the inorganic or organic external soil or humic particles to the treatment system is aided by the incorporation of a lipophilic earth-friendly solvent, preferably ethanol, corn oil, or limonene, within the treatment system. This lipophilic compound will draw the hydrophobic PCB molecules into the treatment system via salvation. The second process is the degradation or dehalogenation of the PCBs. The solvent selection for this process is limited to organic solvents that are capable of donating a hydrogen atom to the PCB structure. Solvents with this ability include, but are not limited to, solvents containing one or more hydroxyl groups (e.g. alcohols) such as methanol, ethanol, and glycerin. This hydrogen atom, as will be described in more detail below, replaces the chlorine atom on the biphenyl ring. Solvents with hydroxyl groups, preferably methanol, ethanol, and glycerin, in the absence of water have been shown to be as effective in the dehalogenation process as pure water. Additionally, the use of this non-water solvent allows the treatment system to be effective over extended periods of time. The previous water-only containing emulsion lost its efficacy within 24 hours after being manufactured. This, as stated earlier, is due to the competing reaction of water and magnesium that leaves oxidized magnesium that is incapable of providing the necessary electrons for the dehalogenation process. The catalyzed zero-valent metal particles are preferably manufactured using a mechanical alloying method. The catalyzed zero-valent metal particles have been optimized for use in the treatment system and preferably comprise 0.1% palladium (Pd) on zero-valent magnesium (Mg), referred to herein as a Mg/Pd bimetal. Although other magnesium bimetals have also been shown to be effective, for example nickel (Ni) coated magnesium (Mg). The Mg/Pd bimetal is a potent hydrodechlorination reagent capable of removing the chlorine from high concentration solutions of chlorocarbons in minutes. The degradation end-product for the dehalogenation of all Arochlor mixtures is the biphenyl ring, which is a benign end-product. Magnesium metal, a powerful reducing agent, reacts with water to form hydrogen gas (H₂) and magnesium hydroxide. Palladium is a well-documented hydrogenation catalyst that chemisorbs molecular hydrogen, weakening the bond between the hydrogen atoms, forming atomic hydrogen bound to the palladium surface. It is hypothesized that the interaction of the bimetallic magnesium/palladium system with a solvent containing available hydrogen moieties (i.e. alcohols or water) results in the generation of atomic hydrogen at particular sites on the metal surface. The bound, atomic hydrogen is available for reaction with PCB molecules in solution yielding a reductive dehalogenation reaction. The proposed reaction mechanism is shown below:
Mg+2H₂O→Mg(OH)₂+H₂
H₂(Pd catalyst)+RCl→RH+HCl
Rapid and almost complete dechlorination of PCBs in aqueous/solvent systems in the presence of the catalyst system described above was demonstrated.

In a preferred embodiment, a mixing device can be used to mix the treatment system into the sediment or it may be pumped into a matrix of concern. The preferred treatment system includes zero-valent magnesium particles coated with palladium (hereinafter referred to as Mg/Pd) that reacts with PCBs during and after mixing over a period of minutes to days, and may either remain in the sediment or be recovered. Introduction of Mg/Pd may be as a bare metal or in a biodegradable solvent reagent paste, which has the dual benefit of stripping strongly bound PCBs into the solvent phase and controlling the rapid oxidation of Mg in water. Alternatively, the catalyzed zero-valent metal particle, preferably Mg/Pd, may be coated with a small amount of a stabilizing agent, such as oil or glycerin, and inserted into the sediment. The oil is preferably a vegetable or mineral oil. However, this method of remediating PCBs may have some disadvantages. The Mg/Pd may become ineffective shortly after the oil is removed from the surface of the Mg/Pd particle through natural degradation of the oil in the sediment. Recovery of Mg/Pd may be possible by introducing the treatment system on a magnetic support like iron particles. This treatment system may be used in combination with others, such as placement of a thin layer cap to minimize subsequent resuspension, or amendment of the benthic layer with a sequestration agent such as activated carbon to treat residuals. Preliminary results have demonstrated up to 99% removal of PCBs in river sediment over a period of 5 days. This treatment system may be used to dechlorinate PCBs in riverine and estuarine sediment in situ or ex situ. A small particle size (e.g. micrometer to mesh-size) zero-valent magnesium particle is coated with a small amount of palladium (˜0.1% by weight), then added to the sediments and mixed. The reaction is allowed to proceed over a period of minutes to days.

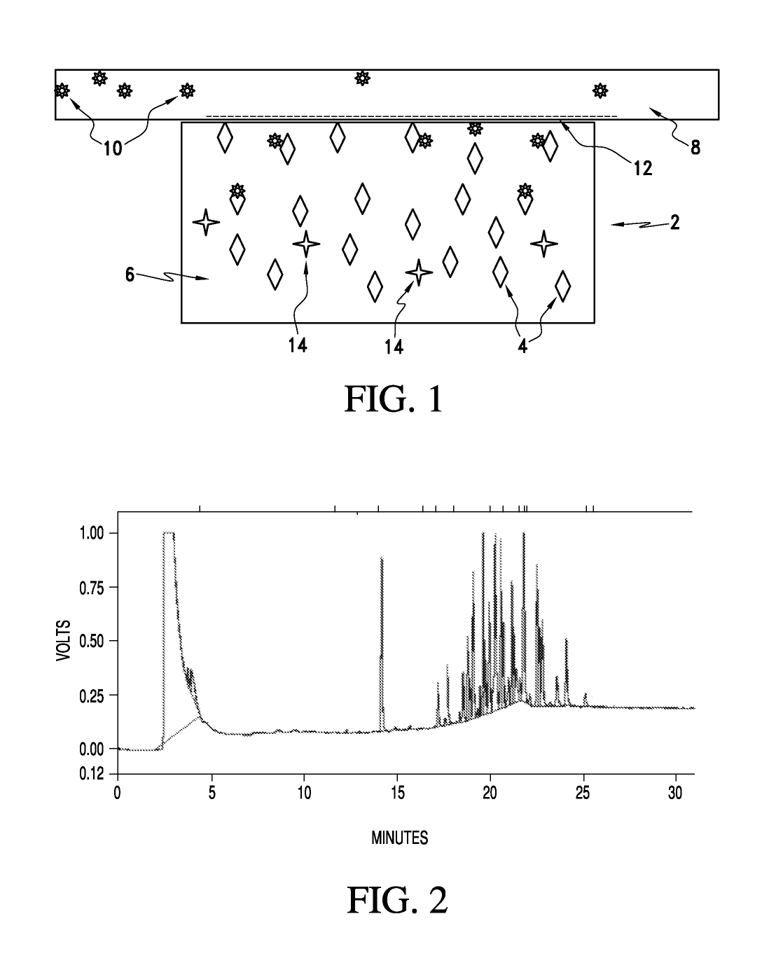

In a second embodiment, the treatment system is applied to ex-situ structures and causes the PCBs to disassociate from the coating, i.e., paint, and the chlorinated aromatics are degraded to biphenyl, the benign by-product. Once the treatment system is in contact with a contaminated structure, the paint softens allowing the PCBs to diffuse into the treatment system and undergo degradation. The PCBs continue to enter, diffuse, and degrade into non-halogenated end-products. FIG. 1 illustrates the manner by which a preferred embodiment of the present invention may be used to treat an ex-situ structure. The treatment system 2 including reactive bimetallic particles 4 in a solvent system 6 degrades a painted structure 8 containing PCBs 10. The treatment system 2 softens the paint at the contact area 12. The PCBs are disassociated from the painted structure 8 and non-chlorinated by-products 14 are contained within the treatment system. Additionally, a second solvent, such as d-limonene, toluene or hexane, may be used in the treatment system as applied to ex-situ structures in order to soften the paint.

It should be understood that the application of a thickened solvent solution without any catalyzed material (e.g. ethanol or limonene with corn starch or other thickener) can be applied to a structure for removing PCBs. This thickened solvent solution would include a hydrogen donating solvent, such as methanol, ethanol or glycerin, and a thickener, such as calcium stearate or a starch. This technique is a subset of the technique described above. Simply using a thickened solvent to remove PCBs from weathered surfaces without degrading the PCBs is an option. Experiments were conducted using this extraction only process and the results are provided in the Experimental Results Section. After the PCBs are removed from the structure, the catalyzed system may be used to degrade the PCBs or the PCBs may be disposed of using other known conventional disposal methods.

In a preferred embodiment, PCBs may be removed from painted structures using the present treatment system. The treatment system has two primary functions: 1) to extract the PCBs from 40 year old material; and 2) to degrade the extracted PCBs. The process for removing PCBs from structures is accomplished as an independent step to the degradation process. The goal is to extract the PCBs out of the paint without destroying the paint and partition the PCBs into an environmentally friendly solvent. Research has indicated that this step can usually be accomplished within the first 24 hours of the treatment system contacting the paint. PCBs are extremely hydrophobic and prefer to be in the treatment system over hardened paint or binder material. The solvent selected for the treatment system must be used to open, but not destroy, the paint's polymeric lattice structure, allowing pathways for PCB movement out of the paint and into the solvent. A number of solvents are available for use within the treatment system. The second process is the degradation or dehalogenation of the PCBs. The solvent selection for this process is limited to solvents that are capable of donating a hydrogen atom to the PCB structure. Solvents with this ability include, but are not limited to, solvents containing one or more hydroxyl groups (alcohols) such as methanol, ethanol, and glycerin.

The following Experiment Results are used to illustrate the beneficial results that are obtained using the present treatment system. However, it should be understood by one of ordinary skill in the art that the treatment system may be modified from these preferred embodiments without departing from the scope of the present invention.

### Experimental Results

Sediments

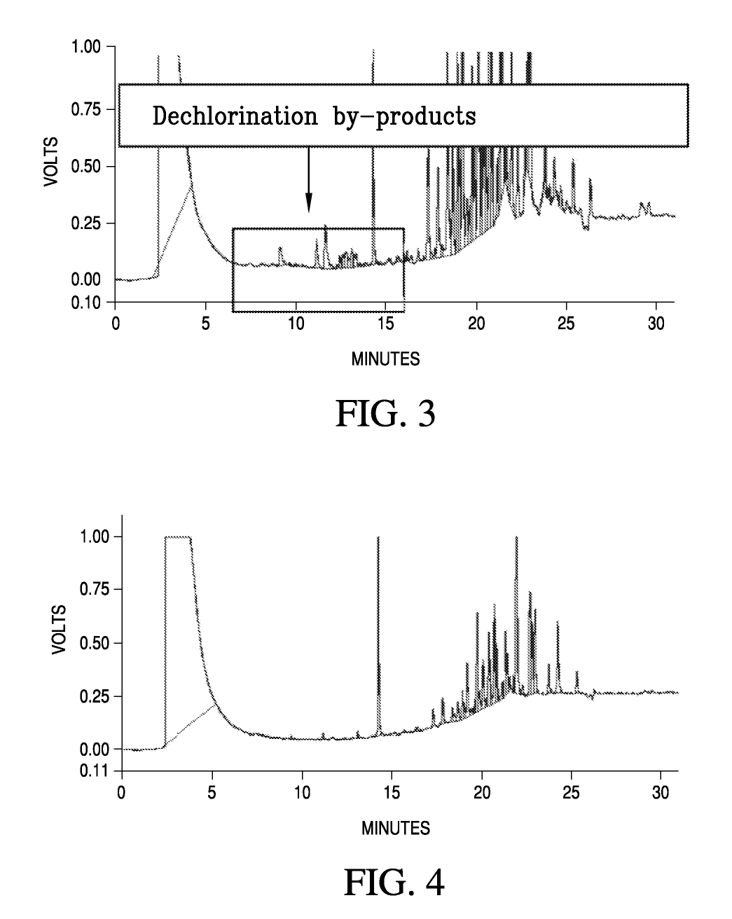

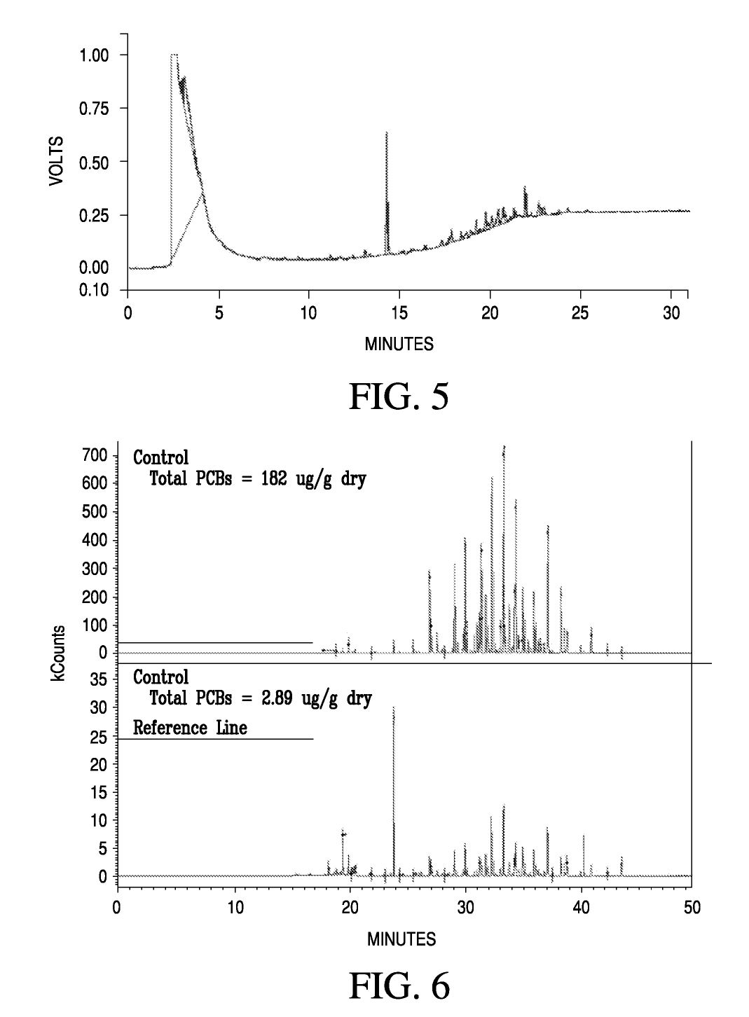

FIG. 2 shows a chromatogram of a control sample of an Arochlor 1260 standard. This standard is treated with Mg/Pd in a methanol/water solution (10%/90%). FIG. 3 shows a chromatogram of the treated sample after 5 minutes. Lesser chlorinated PCBs are clearly visible at 5 minutes, indicating stepwise dechlorination is the likely mechanism responsible for the observed loss of PCBs from the solution. FIG. 4 shows a chromatogram of the treated sample after 1 hour. FIG. 5 shows a chromatogram of the treated sample after 4 hours.

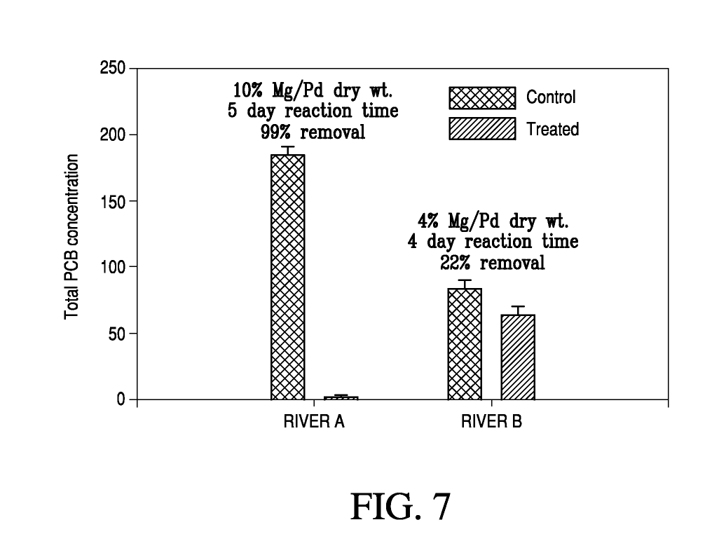

Experiments were also conducted using sediments from two different rivers, River A and River B, to assess the efficacy of the neat (bare) Mg/Pd material in actual, aged, PCB-contaminated sediments. Mg/Pd was added to flasks containing a sediment slurry (approximately 25% water addition to in-situ water content conditions), and were gently mixed 4 days on an oscillatory shaker table. A typical chromatogram from the River A sediment showing control sample and a treated sample are shown in FIG. 6 (note reference line for change in scale between upper and lower figure). FIG. 7 shows results from both River A sediments (sandy with low organic carbon content) and River B (fine-grained with very high organic carbon content). These results indicated a clear need to evaluate the change in bioaccumulation from sediments for which removal percentages are low and the need to develop and evaluate formulations incorporating solvents to increase the availability of PCBs for dechlorination.

Painted Structures

Due to the wide variety of structural properties associated with each specific PCB-laden paint, the choice of solvent(s) incorporated into the treatment system is specific to the paint being treated. Experiments have shown that solvent systems that work very well at softening and removing the PCBs found in one variety of paint can be ineffective when applied to another. Therefore, the final formulation of the treatment system must be determined in the laboratory, using paint samples from the proposed area prior to determining the final formulation of the treatment system to apply. The data provided below illustrates the ability of the treatment system to remove PCBs and degrade them from painted structures.

Additional treatment system formulation properties that must be addressed for each site-specific application include viscosity and stability. The treatment system must be viscous or thick enough to remain where it is applied on the structure. Several thickening agents have been tested. Adding a stabilizing agent ensures that the treatment system will not evaporate and leave the unprotected catalyzed zero-valent metal particle exposed. Due to the extreme reactivity of the treatment system, the choice of thickening agents and stabilizing agents is complex. During the testing of the treatment system, a number of reagents were evaluated to ensure the rate of dehalogenation was not inhibited by its addition to the system. The following tables include examples of the data obtained with the addition of glycerin as a stabilizing agent and thickener, showing no interference of this additive on the PCB reduction potential.

The following Tables demonstrate the efficacy of the treatment system with various solvent systems. Table 1 illustrates the typical results achieved in an aqueous treatment system comprised of water and 10% methanol. Methanol was then added to the water to make the solution more organic in nature increasing the solubility levels of PCBs in the stock solution. Due to safety concerns associated with the large production of hydrogen atoms when the Mg/Pd was added to the water, pure methanol and ethanol solutions were substituted and tested, resulting in similar rates of reduction as shown in Table 2 and 3.

TABLE 1
Exposure of Aroclor 1260 in a 10% methanol in water
solution to a 1.0 g Mg/Pd catalyst system

| | Aroclor 1260 | % PCB |
|---|---|---|
| Sample Identification | (mg/l) | Degradation |
| Extracted Standard (no Mg/PD added) | 5.9 | N/A |
| Standard exposed to Mg/Pd 1.0 hr | 0.4 | 92% |
| Standard exposed to Mg/Pd 4.0 hr | <0.1 | >98% |
| Standard exposed to Mg/Pd 4.0 hr dup | <0.1 | >98% |

TABLE 2
Exposure of Aroclor 1254 in Methanol
only to a 0.5 g Mg/Pd catalyst system

| | Aroclor 1254 | % PCB |
|---|---|---|
| Sample Identification | (mg/l) | Degradation |
| Extracted Standard (no Mg/PD added) | 5.5 | N/A |
| Standard exposed to Mg/Pd 0.5 hr | 0.3 | 95% |
| Standard exposed to Mg/Pd 1.0 hr | <0.1 | >98% |
| Standard exposed to Mg/Pd 2.0 hr dup | <0.1 | >98% |
| Standard exposed to Mg/Pd I 4.0 hr | <0.1 | >98% |

TABLE 3
Comparison of Aroclor 1260 standards in ethanol-glycerin
solution Containing 1.0 g of Mg/Pd

| | Aroclor 1260 | % PCB |
|---|---|---|
| Sample Identification | (mg/l) | Degradation |
| Extracted Standard (no Mg/PD added) | 10.6 | N/A |
| Standard exposed to Mg/Pd 24 hr | 0.4 | 92% |
| Standard exposed to Mg/Pd 4.0 hr | <0.1 | >98% |
| Standard exposed to Mg/Pd 4.0 hr dup | <0.1 | >98% |

As is evident from the data found in Table 1-3, the degradation of PCBs can be achieved rapidly and completely in the presence of the present treatment system.

Table 4 shows the experimental results obtained using a Aroclor 1260 standard. This testing was performed in order to determine whether the addition of glycerin would hinder the PCB degradation. As can be seen from this Table, the addition of glycerin to the treatment system does not inhibit the degradation of PCBs.

TABLE 4
Comparison of Aroclor 1260 standards in ethanol
with and without the addition of glycerin

| | Aroclor | % PCB |
|---|---|---|
| Sample Identification | 1260 mg/l) | Degradation |
| Extracted Standard (no Mg/PD added) | 10.6 | N/A |
| Standard exposed to Mg/Pd 24 hr | <0.1 | >99% |
| Standard exposed to Mg/Pd 24 hr (dup) | <0.1 | >99% |
| Standard exposed to Mg/Pd with glycerin | <0.1 | >99% |
| Standard exposed to Mg/Pd with glycerin | <0.1 | >99% |
| (dup) | | |

Table 5 provides the results of experiments conducted using the treatment system to dehalogenate PCBs. The results were analyzed using GC/MS. This testing was performed to determine whether the addition of starch inhibited PCB degradation.

TABLE 5
Thickening Tests - Determination if the addition of starch
as a thickener inhibits the dehalogenation of PCBs

| | Percent Reduction of |
|---|---|
| Sample ID | Aroclor 1260 |
| Standard (No BTS or Starch) 100 mg/l | 0 |
| Standard plus BTD | 84 |
| Standard plus BTS | 95 |
| Standard plus BTS Starch | 85 |
| Standard plus BTS Starch - dup | 85 |
| Standard plus BTS Starch | 89 |

Table 6 shows the results of tests conducted in order to determine the ability of solvents, in this case limonene, to remove PCBs from Galbestos, a construction material used formerly with Roberston Metal Buildings. The Table shows the application of multiple dips of the Galbestos structure from hanger 1 at Moffett Field in solvents.

TABLE 6
Analyzed by GC/ECD

| | Aroclor 1268 (mg/Kg) | |
|---|---|---|
| Sample ID | Approximate | Percent PCB removal |
| Hanger Control- | 160000 | |
| Sample A 10 dips | 13 | >99 |
| Sample B 10 dips | 10 | >99 |
| Sample C 10 dips | 10 | >99 |

Table 7 shows the results of tests conducted to evaluate the various solvents for the extraction efficiency to remove PCBs from Galbestos material in hanger 1 at Moffett Field.

TABLE 7
Analyzed by GC/ECD

| Galbestos Samples Extracted in the following | Approximate |
|---|---|
| solvents | Aroclor 1268 Extracted |
| Methanol | 29000 |
| Ethanol | 33000 |
| Hexane | 62000 |
| Limonene | 71000 |

Although the present invention has been disclosed in terms of a number of preferred embodiments, it will be understood that numerous modifications and variations could be made thereto without departing from the scope of the invention as defined by the following claims:

We claim:

1. A treatment system comprising:
a plurality of catalyzed zero-valent metal particles; and, an organic hydrogen donating solvent.

2. The treatment system of claim 1, wherein said organic hydrogen donating solvent is an alcohol.

3. The treatment system of claim 2, wherein said alcohol is selected from the group consisting of a diol, a triol, methanol, ethanol, glycerin, and mixtures thereof.

4. The treatment system of claim 1, further comprising a second solvent.

5. The treatment system of claim 4, wherein said second solvent is selected from the group consisting of d-limonene, toluene, hexane, and mixtures thereof.

6. The treatment system of claim 1, wherein said organic hydrogen donating solvent includes an organic compound and water.

7. The treatment system of claim 6, wherein said organic compound is an alcohol.

8. The treatment system of claim 7, wherein said alcohol is selected from the group consisting of a diol, a triol, methanol, ethanol, glycerin, and mixtures thereof.

9. The treatment system of claim 6, further comprising a second solvent.

10. The treatment system of claim 9, wherein said second solvent is selected from the group consisting of d-limonene, toluene, hexane, and mixtures thereof.

11. The treatment system of claim 1, further comprising a thickener.

12. The treatment system of claim 11, wherein said thickener is calcium stearate or a starch.

13. The treatment system of claim 6, further comprising a thickener.

14. The treatment system of claim 13, wherein said thickener is calcium stearate or a starch.

15. The treatment system of claim 1, further comprising a stabilizer.

16. The treatment system of claim 15, wherein said stabilizer is selected from the group consisting of glycerin, mineral oil, vegetable oil, and mixtures thereof.

17. The treatment system of claim 6, further comprising a stabilizer.

18. The treatment system of claim 17, wherein said stabilizer is selected from the group consisting of glycerin, mineral oil, vegetable oil, and mixtures thereof.

19. The treatment system of claim 1, further comprising a thickener and a stabilizer.

20. The treatment system of claim 6, further comprising a thickener and a stabilizer.

21. The treatment system of claim 1, wherein said plurality of catalyzed zero-valent metal particles includes a plurality of zero-valent metal particles coated with a catalytic metal.

22. The treatment system of claim 21, wherein said plurality of zero-valent metal particles are zero-valent magnesium particles or zero-valent iron particles.

23. The treatment system of claim 22, wherein said catalytic metal is a noble metal.

24. The treatment system of claim 23, wherein said noble metal is selected from the group consisting of palladium, nickel, zinc, and mixtures thereof.

25. The treatment system of claim 21, wherein said catalytic metal is a noble metal.

26. The treatment system of claim 25, wherein said noble metal is selected from the group consisting of palladium, nickel, zinc, and mixtures thereof.

27. The treatment system of claim 6, wherein said plurality of catalyzed zero-valent metal particles includes a plurality of zero-valent metal particles coated with a catalytic metal.

28. The treatment system of claim 27, wherein said plurality of zero-valent metal particles are zero-valent magnesium particles or zero-valent iron particles.

29. The treatment system of claim 28, wherein said catalytic metal is a noble metal.

30. The treatment system of claim 29, wherein said noble metal is selected from the group consisting of palladium, nickel, zinc, and mixtures thereof.

31. The treatment system of claim 27, wherein said catalytic metal is a noble metal.

32. The treatment system of claim 31, wherein said noble metal is selected from the group consisting of palladium, nickel, zinc, and mixtures thereof.

33. A method for treating a contaminated natural media comprising:
applying a treatment system comprised of a plurality of catalyzed zero-valent metal particles and an organic hydrogen donating solvent to a contaminated natural media.

34. The method of claim 33, wherein said plurality of catalyzed zero-valent metal particles includes a plurality of zero-valent metal particles coated with a catalytic metal.

35. The method of claim 34, wherein said plurality of zero-valent metal particles includes a plurality of zero-valent magnesium particles or a plurality of zero-valent iron particles.

36. The method of claim 35, wherein said catalytic metal is a noble metal.

37. The method of claim 36, wherein said noble metal is selected from the group consisting of palladium, nickel, zinc, and mixtures thereof.

38. The method of claim 34, wherein said catalytic metal is a noble metal.

39. The method of claim 38, wherein said noble metal is selected from the group consisting of palladium, nickel, zinc, and mixtures thereof.

40. The method of claim 33, wherein said organic hydrogen donating solvent is an alcohol.

41. The method of claim 40, wherein said alcohol is selected from the group consisting of a diol, a triol, methanol, ethanol, glycerin, and mixtures thereof.

42. The method of claim 33, further comprising removing polychlorinated biphenyls from said contaminated natural media.

43. A method for treating an ex situ structure comprising:
applying a treatment system comprised of a plurality of catalyzed zero-valent metal particles and an organic hydrogen donating solvent to said ex situ structure.

44. The method of claim 43, wherein said plurality of catalyzed zero-valent metal particles includes a plurality of zero-valent metal particles coated with a catalytic metal.

45. The method of claim 44, wherein said plurality of zero-valent metal particles includes a plurality of zero-valent magnesium particles or zero-valent iron particles.

46. The method of claim 45, wherein said catalytic metal is a noble metal.

47. The method of claim 46, wherein said noble metal is selected from the group consisting of palladium, nickel, zinc, and mixtures thereof.

48. The method of claim 44, wherein said catalytic metal is a noble metal.

49. The method of claim 48, wherein said noble metal is selected from the group consisting of palladium, nickel, zinc, and mixtures thereof.

50. The method of claim 43, wherein said organic hydrogen donating solvent is an alcohol.

51. The method of claim 50, wherein said alcohol is selected from the group consisting of a diol, a triol, methanol, ethanol, glycerin, and mixtures thereof.

52. The method of claim 43, wherein said treatment system further comprises a second solvent.

53. The method of claim 52, wherein said second solvent is selected from the group consisting of d-limonene, toluene, hexane, and mixtures thereof.

54. The method of claim 43, further comprising removing polychlorinated biphenyls from said ex-situ structure.

55. A treatment system comprising a plurality of catalyzed zero-valent metal particles coated with an oil.

56. The treatment system of claim 55 wherein said plurality of catalyzed zero-valent metal particles includes a plurality of zero-valent metal particle coated with a catalytic metal.

57. The treatment system of claim 56, wherein said plurality of zero-valent metal particles are a plurality of zero-valent magnesium particles or zero-valent iron particles.

58. The treatment system of claim 57, wherein said catalytic metal is a noble metal.

59. The treatment system of claim 58, wherein said catalytic metal is selected from the group consisting of palladium, zinc, nickel, and mixtures thereof.

60. The treatment system of claim 56 wherein said catalytic metal is a noble metal.

61. The treatment system of claim 60, wherein said noble metal is selected from the group consisting of palladium, zinc, nickel, and mixtures thereof.

62. The treatment system of claim 55 wherein said oil is selected from the group consisting of mineral oil, vegetable oil, and mixtures thereof.

63. A method for treating a natural media comprising:
applying a plurality of catalyzed zero-valent metal particles coated with a stabilizing agent to said natural media.

64. The method of claim 63, wherein said stabilizing agent is selected from the group consisting of an oil, glycerin, and mixtures thereof.

65. The method of claim 63, wherein said plurality of catalyzed zero-valent metal particles includes a plurality of zero-valent metal particles coated with a catalytic metal.

66. The method of claim 65, wherein said plurality of zero-valent metal particles includes a plurality of zero-valent magnesium particles or zero-valent iron particles.

67. The method of claim 66, wherein said catalytic metal is a noble metal.

68. The method of claim 67, wherein said noble metal is selected from the group consisting of palladium, nickel, zinc, and mixtures thereof.

69. The method of claim 65, wherein said catalytic metal is a noble metal.

70. The method of claim 69, wherein said noble metal is selected from the group consisting of palladium, nickel, zinc, and mixtures thereof.

71. The method of claim 64, wherein said oil is selected from the group consisting of a vegetable oil, a mineral oil, and mixtures thereof.

72. The method of claim 63, further comprising removing polychlorinated biphenyls from said natural media.

73. A method for treating an ex-situ structure comprising:
applying a mixture including an organic hydrogen donating solvent and a thickener to said ex-situ structure.

74. The method of claim 73, wherein said organic hydrogen donating solvent is an alcohol.

75. The method of claim 74, wherein said alcohol is selected from the group consisting of a diol, a triol, methanol, ethanol, glycerin, and mixtures thereof.

76. The method of claim 73, wherein said thickener is calcium stearate or a starch.
